(19) United States
(12) Patent Application Publication
(10) Pub. No.: US 2025/0034016 A1
(43) Pub. Date: Jan. 30, 2025

(54) METHOD OF PRODUCING WATER TREATMENT AGENT FOR SOLVING SILICA SCALE PROBLEM

(71) Applicants: HIROYUKI KOIKE, KANAGAWA (JP); CALFA CHEMICAL CO., LTD., KANAGAWA (JP)

(72) Inventors: HIROYUKI KOIKE, KANAGAWA (JP); KEIJI KOIKE, KANAGAWA (JP)

(73) Assignees: HIROYUKI KOIKE, KANAGAWA (JP); CALFA CHEMICAL CO., LTD., KANAGAWA (JP)

(21) Appl. No.: 18/551,944

(22) PCT Filed: Feb. 3, 2023
(86) PCT No.: PCT/JP2023/004477

§ 371 Date: Sep. 22, 2023

(30) Foreign Application Priority Data
Aug. 29, 2022 (JP) 2022-135838

(51) Int. Cl. C02F 5/08; C02F 101/00

(52) U.S. Cl. CPC C02F 5/083; C02F 2101/006

(57) ABSTRACT

A method of producing a water treatment agent for inhibiting and removing a silica scale includes the steps of continuously cooling a metal mold with a flowing water, using SiO2, and NaO2 as a main component, mixing any of Al2O3, MgO and B2O3, heating and melting them to a temperature between 1200° C. and 1300° C., and storing them within the metal mold, pouring the cooling water like a shower, cooling a temperature of the material up to around 800° C., and solidifying the material, reversing the metal mold and dropping the solidified material onto a net, pouring the cooling water again thereto and cooling the material up to around 500° C., moving it onto the other net, pouring the cooling water again, and cooling the material up to around 100° C., and naturally drying and naturally cooling. The invention provides the water treatment agent with cracks having a depth between 1.0 mm and 1.5 mm.

### TECHNICAL FIELD

The present invention relates to a method of producing a water treatment agent for solving a silica scale problem, and more particularly to a method of producing a massive water treatment agent of a water-soluble amorphous in which a crack having a depth between 1.0 mm and 1.5 mm is formed from upper and lower surfaces.

### BACKGROUND ART

In a water channel system which supplies a cooling water to an air conditioning equipment, a refrigeration device and a heat exchanger, scales are generated with the use thereof. Further, due to attachment of the scales to an inner surface of the water channel system, various problems such as a local corrosion, a clogging of the water channel system, a reduction of a heat exchanger effectiveness and an increase of a pressure loss are caused.

In order to prevent the problem in the water channel system, the water channel system is cleaned at the same time that the water in the water channel system is periodically replaced. In addition, chemicals are put in the water within the water channel system. Further, most of the chemicals is made of an organic compound.

Therefore, it is an urgent issue to prevent attachment of a heat conduction inhibitor (scale), in particular silica scale to a surface of a plate within a pipe arrangement and a heat exchanger constructing the water channel system without stopping an operation of the device.

Further, in silica and calcium among the scale component, the reduction of the heat conductivity in the silica is twice as large as that of the calcium under the same thickness. Then, in the conventional water channel system, it has been an urgent issue to prevent the attachment of the scale to the inner surface of the pipe arrangement constructing the water channel system and effectively remove the silica scale depositing in the pipe arrangement.

Two methods of preventing the scale and removing the scale have been proposed as a conventionally provided scale countermeasure. One is preventing the scale from being generated, and another is removing the scale which is generated in the plate within the pipe arrangement and within the heat exchanger.

In a particular means, for the scale prevention countermeasure, a polymer coagulant of a phosphonic acid system, a polyacrylic acid system or a polymaleic acid system is generally used for a fine particle causing the scale in a case of the calcium scale, and is injected into the water channel system, and the fine particle causing the scale is formed as a coarse floc and discharged out of the cooling water system together with the drainage water. Further, generally, a filter utilizing a membrane, a strainer, sand and anthracite is frequently used. However, the polymer coagulants mentioned above do not actually have a sufficient effect for the silica scale.

On the other hand, for the method of removing the scale which is generated in the plate within the pipe arrangement and within the heat exchanger, there is performed a method of stopping an operation of a system and putting chemicals (dilute hydrochloric acid or dilute sulfuric acid) in a circulating water system of a plate portion in the heat exchanger, and removing the scale of the calcium scale by a circulation cleaning (called as non-opened cleaning), and the waste liquid is chemically treated and is disposed.

However, for the removal of the silica scale, a sufficient effect cannot be obtained by the chemical cleaning based on the non-opened cleaning, and a wide reduction of an operating rate comes to a great problem.

Therefore, in order to remove the silica scale, the non-opened cleaning is not generally performed, it is necessary to stop the operation of the system, disassemble and remove the plates each having a large weight between several Kg and several tens Kg, and clean the plates one by one with the use of hazardous chemicals (ammonium difluoride). As a result, the plate of the heat exchanger is corroded.

Therefore, there has been employed a method of replacing the plate with a separately prepared new plate or a different plate which is previously cleaned by a physical cleaning such as a brush cleaning, which is called as a plate rotation system.

In the means for removing the silica scale, a lot of labor hour and economical burden have been immeasurably required as is different from the calcium scale removal.

The description is given mainly of the plate type heat exchanger, however, a generally frequently used shell and tube type heat exchanger has the same problem.

### SUMMARY OF INVENTION

### Technical Problem

As mentioned above, the water channel system has been conventionally cleaned at the same time when the water within the water channel system has been periodically replaced, and the chemicals have been put in the water within the water channel system, in order to prevent the problem in the water channel system by preventing the scale from being generated in the water channel system and being attached thereto. However, in order to always keep the state of the water channel system good, it is necessary to frequently perform the troublesome maintenance of the water channel system. Further, the chemicals made of the organic compound which is put in the water within the water channel system when performing the work mentioned above has a high risk and may adversely affect the worker and the surrounding environment, and the water channel system may be damaged if a concentration of the chemicals is wrong.

The present invention is made by taking the point mentioned above into consideration, and intends to provide a method of producing a water treatment agent which can be easily performed the maintenance for preventing a trouble in the water channel system, can be safely performed the maintenance work, does not adversely affect the environment, is in no danger of damaging the water channel system, and is adapted not to disappear for a certain period about three to four months without dissolving for a short period of time in the water within the water channel system.

The water treatment agent produced by the producing method according to the present invention intends to provide the method of producing the unprecedented water treatment agent, which can automatically dissolve and remove the silica scale which can not be dissolved and removed by the conventional flocculant-based water treatment agent, without stopping the operation of the device, by achieving the urgent issue of dissolving the silica scale.

The present water treatment agent is a water treatment agent which can inhibit and remove the silica scale which can not be inhibited and removed by the conventional water treatment agent, and also has a sufficient inhibiting effect for the other scales, for example, a calcium scale, than the silica scale.

### Solution to Problem

Accordingly, an outline of the present invention exists in a method of producing a water treatment agent which can inhibit and remove a silica scale, the method is characterized by including the following steps a to g.
a. continuously cooling a metal mold with a flowing water by arranging the metal mold in the flowing water except an upper portion of the metal mold.
b. using silicone oxide (SiO2), and sodium oxide (Na2O) as a main component, mixing one kind or plural kinds of aluminum oxide (Al2O3), magnesium oxide (MgO) or boron oxide (B2O3) as occasion demands, heating and melting them to a temperature between 1200° C. and 133° C., and storing them within the metal mold. When injecting the materials, the materials are injected to a position which is a little below an upper edge of a cavity in the metal mold.
c. next, pouring the cooling water like a shower from the above of the stored material in such a manner as to be uniform after 10 seconds to 20 seconds has passes after storing in the metal mold, cooling a temperature of the material up to around 800° C., and solidifying the material.
d. next, reversing the metal mold and dropping the solidified material onto a net.
e. thereafter, pouring the cooling water again thereto for 30 seconds to 40 seconds from the above and the below and cooling the material up to around 500° C.
f. next, moving it onto the other net, pouring the cooling water again for 30 seconds to 40 seconds from the above and the below, and cooling the material up to around 100° C.
g. thereafter, naturally drying and naturally cooling. Thus, the massive water treatment agent of the water-soluble amorphous is completed. This water treatment agent can inhibit and remove the silica scale, and cracks each having a depth between 1.0 mm and 1.5 mm are formed in the water treatment agent from upper and lower surfaces.

### Effect of Invention

According to the producing method of the present invention, it is possible to produce the massive water treatment agent of the water-soluble amorphous in which the crack having the depth between 1.0 mm and 1.5 mm is formed from the upper and lower surfaces.

Further, the water treatment agent produced by the present invention is the massive water treatment agent of the water-soluble amorphous, and is adapted to use the sodium oxide (Na2O) and the silicone oxide (SiO2) as the main component in the composition, and include the aluminum oxide (Al2O3), the magnesium oxide (MgO) and the boron oxide (B2O3) as occasion demands. Further, by putting the massive water treatment agent of the water-soluble amorphous in the water, the massive water treatment agent dissolves little by little, and a sodium ion, a silicon ion, an aluminum ion and a boron ion elute little by little. Further, due to the action of the sodium ion among them, the scale can be preliminarily prevented from being generated within the water channel system, and the scale already attached to the water channel system is simultaneously softened and peeled.

Next, a description will be given of a mechanism of removing the scale by the sodium ion within the water channel system caused by the water treatment agent which is dissolved in the water within the water channel system.

The scale generated in the heat exchanger and the pipe arrangement is mainly constituted by elements of silicon (Si), calcium (Ca), magnesium (Mg) and iron (Fe). On the other hand, due to the dissolving of the massive water treatment agent of the water-soluble amorphous into the water within the water channel system, natrium (Na) eluting into the water reacts with the water to form a sodium hydroxide (2NaOH), and the sodium hydroxide dissolves the silicone (Si) in the scale component. Since the silicone (Si) corresponding to a binder in the scale component dissolves and elutes into the water, the calcium (Ca) and the magnesium (Mg) corresponding to the other scale components also dissolve into the water together. At this time, the calcium (Ca) and the magnesium (Mg) do not dissolve by the sodium hydroxide, but drop out as a fine aggregation substance. Therefore, the scale generated in the water channel system (plate in the inner portion of the pipe arrangement or the heat exchanger) comes to the aggregation substance of calcium and magnesium between 2 μm and 20 μm and is removed little by little.

Further, the water treatment agent produced by the present invention is the massive water treatment agent of the water-soluble amorphous, and is adapted to have the silicone oxide (SiO2) and the sodium oxide (Na2O) as the main component in the composition, and further include one kind or plural kinds of the aluminum oxide (Al2O3), the magnesium oxide (MgO) and the boron oxide (B2O3) as occasion demands. Further, these materials are made of the inorganic compound, and is therefore in no danger of adversely affecting the worker and the surrounding environment and is in no danger of damaging the water channel system.

In addition, the water treatment agent produced by the present invention is the massive water treatment agent of the water-soluble amorphous and has the crack having the depth between 1.0 mm and 1.5 mm formed from the upper and lower surface. Therefore, the water treatment agent does not disappear for a period between about 3 months and four months and can keep a medicinal effect without eluting for a short period of time when being put in the water within the water channel system.

More specifically, on the assumption that the surface of the water treatment agent is a complete flat surface when the water treatment agent is put in the water within the water channel system, the period before disappearing after dissolving is elongated since the contact area with the water is small, however, an amount of elution of the component into the water is small. Therefore, a sufficient medicinal effect can not be obtained. Further, on the contrary, if a deep crack exists on the surface of the water treatment agent, the amount of elution of the component into the water is increased due to the increase of the contact area with the water, however, the water treatment agent collapses from the crack to scatter, and the period before disappearing after dissolving becomes extremely short. More specifically, a service life thereof is shortened.

Thus, the water treatment agent produced by the present invention is adapted to form the crack having the depth between 1.0 mm and 1.5 mm from the upper and lower surfaces, and accordingly has a greater contact area with the water than that of the agent having a flat surface. Therefore, the amount of elution of the component into the water is increased, and does not collapse. As a result, it is possible to elongate the period before disappearing after dissolving in comparison with the case where the deep crack is formed.

### BRIEF DESCRIPTION OF DRAWINGS

FIG. 1 is a perspective view of a state in which a metal mold used in a producing method according to the present invention is arranged in a flowing water.

FIG. 2 is a partly enlarged vertical cross sectional view of the same.

FIG. 3 is an explanatory view of the producing method according to the present invention, and shows a state in which a molten material is injected into a cavity in the metal mold.

FIG. 4 is an explanatory view of the producing method according to the present invention, and shows a state in which a material is cooled by pouring a cooling water to be solidified, and the solidified material is thereafter dropped onto a net by reversing the metal mold.

FIG. 5 is a central vertical cross sectional view of a water treatment agent which is completed through all the producing steps.

FIG. 6 is a perspective view of a water passing container which is used when putting the water treatment agent produced by the producing method according to the present invention into the water.

FIG. 7 is an explanatory view of a method of using the water treatment agent which is produced by the producing method according to the present invention.

### DESCRIPTION OF EMBODIMENTS

A description will be given below of a method of producing a water treatment agent according to the present invention with reference to the accompanying drawings.

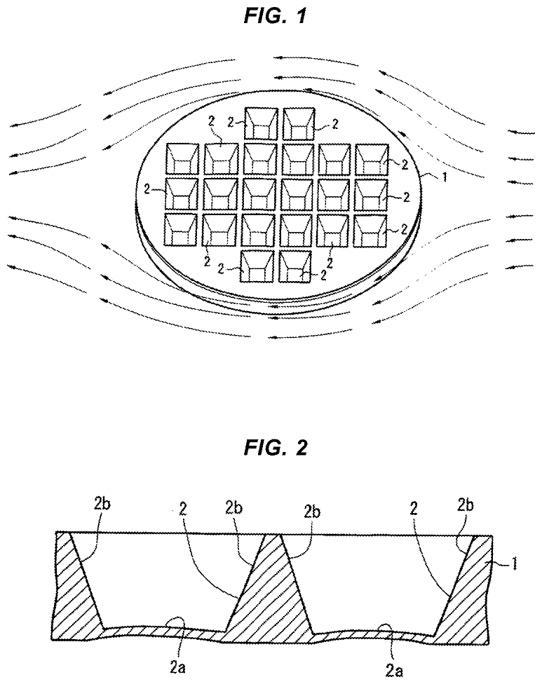

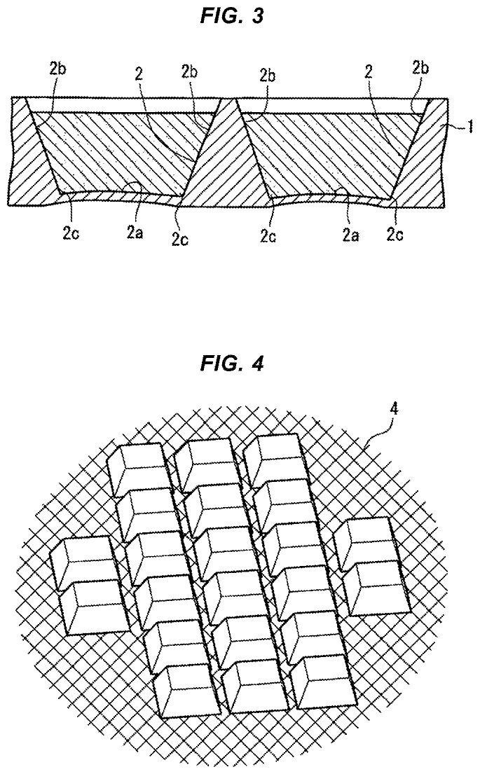

In FIG. 1, reference numeral 1 denotes a metal mold which is used in a method of producing a water treatment agent according to the present invention. The metal mold employs a cast iron or a metal which can withstand a temperature of 1300° C. for the material thereof. Further, the metal mold 1 is provided with a lot of cavities 2, 2, 2, . . . at an appropriate arrangement so that a lot of water treatment agents can be produced at a time, in the present embodiment. Further, each of the cavities 2 is formed into a curved surface in which a bottom portion 2a thereof is convex upward (refer to FIGS. 2 and 3), and can therefore cool a peripheral portion 2c efficiently. Further, the cavity 2 is expanded from the bottom portion 2a to a top edge to form a slope face 2b. Thus, the metal mold 1 can be smoothly reversed and the material can be smoothly taken out. The cavity 2 according to the present invention is not limited to this shape, but can employ appropriate shapes as long as the material can be taken out. Further, as shown in FIG. 1, the metal mold 1 is continuously cooled with a flowing water during production of the water treatment agent, by arranging the metal mold 1 in the flowing water except an upper portion of the metal mold.

Further, reference numeral 3 denotes a water passing container which is used when the water treatment agent produced by the producing method according to the present invention is put into the water (refer to FIG. 6). Further, the water passing container 3 is made of plastics and numberless holes 3a, 3a, 3a, . . . are formed on a peripheral surface thereof. Further, reference numeral 4 denotes a net to which the solidified material taken out of the metal mold is put.

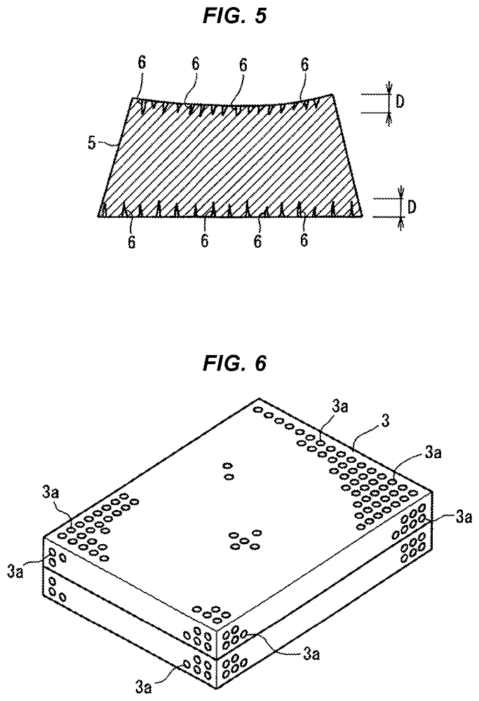

Accordingly, the method of producing the water treatment agent according to the present invention is performed by the use of the metal mold 1, and includes the following steps.
a. continuously cooling a metal mold with a flowing water by arranging the metal mold in the flowing water except an upper portion of the metal mold (refer to FIG. 1).
b. using silicone oxide (SiO2), and sodium oxide (Na2O) as a main component, mixing one kind or plural kinds of aluminum oxide (Al2O3), magnesium oxide (MgO) or boron oxide (B2O3) as occasion demands, heating and melting them to a temperature between 1200° C. and 1300° C., and storing them within the metal mold. When injecting the materials, the materials are injected to a position which is a little below an upper edge of a cavity in the metal mold (refer to FIG. 3).
c. next, pouring the cooling water like a shower from the above of the stored material in such a manner as to be uniform after 10 seconds to 20 seconds has passes after storing in the metal mold, cooling a temperature of the material up to around 800° C., and solidifying the material.
d. next, reversing the metal mold and dropping the solidified material onto a net (refer to FIG. 4).
e. thereafter, pouring the cooling water again thereto for 30 seconds to 40 seconds from the above and the below and cooling the material up to around 500° C.
f. next, moving it onto the other net, pouring the cooling water again for 30 seconds to 40 seconds from the above and the below, and cooling the material up to around 100° C.
g. thereafter, naturally drying and naturally cooling. Thus, the massive water treatment agent of the water-soluble amorphous is completed. In the water treatment agent, cracks each having a depth between 1.0 mm and 1.5 mm are formed from upper and lower surfaces (refer to FIG. 5).

Reference numeral 5 denotes a massive water treatment agent of a water-soluble amorphous which is produced by the producing method according to the present invention, and the water treatment agent is formed into a trapezoidal shape. The shape of the water treatment agent 5 is not limited to the illustrated one, but may be formed into the other shapes by changing the shape of the concave portion of the metal mold. Further, a thickness of the water treatment agent may be set to be thinner than the illustrated one. Further, as shown in FIG. 5, numberless cracks 6, 6, 6, . . . each having a depth (D) between 1.0 mm and 1.5 mm from a surface thereof are formed in the upper and lower surfaces thereof.

The cracks 6, 6, 6 . . . are formed on the upper and lower surfaces of the massive water treatment agent 5 of the water-soluble amorphous due to a sudden temperature difference. By performing the sudden temperature difference, the cracks 6, 6, 6 . . . having the depth between 1.0 mm and 1.5 mm from the surface can be formed.

Further, the massive water treatment agent 5 of the water-soluble amorphous produced by the producing method according to the present invention is used for the water channel system (regardless of a circulating system and a noncirculating system) which supplies the cooling water to the air conditioning equipment, the refrigeration device and the heat exchanger, and a case where a cooling device using a cooling tower is employed is shown in the present embodiment.

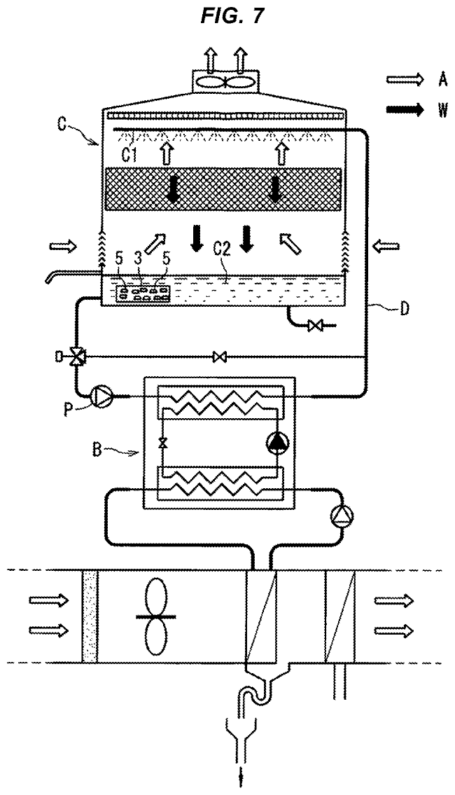

As shown in FIG. 7, the massive water treatment agent is adapted to be put in a water channel system D which is disposed between a cooling tower C and a heat exchanger B. The water channel system D is adapted to connect between a water discharge portion C1 in an upper portion within the cooling tower C, and a storage portion C2 positioned below the water discharge portion C1 via the heat exchanger B, and is structured such that the water within the water channel system D is circulated by a pump P. The massive water treatment agent 5 of the water-soluble amorphous produced by the producing method according to the present invention is adapted to be thrown in the water passing container 3 and be put in the storage portion C2. An arrow A in the drawing denotes a flow of air, and an arrow W denotes a flow of water.

As mentioned above, the silica scale is always and continuously inhibited from being generated and attached within the water channel system, and removed during the period that the massive water treatment agent 5 of the water-soluble amorphous produced by the producing method according to the present invention is put in. Therefore, the attachment of the scale within the water channel system can be reduced as much as possible as well as it is possible to easily perform the maintenance of the water channel system. As a result, a pressure loss of the water channel system can be reduced, and it is possible to improve a heat transmission efficiency, thereby achieving an economical operation.

Further, the massive water treatment agent 5 of the water-soluble amorphous produced by the producing method according to the present invention is adapted to include the sodium oxide, the silicone oxide, the aluminum oxide and the boron oxide in the composition thereof, and these materials are constituted by the inorganic compound. Therefore, the massive water treatment agent 5 is in no danger of adversely affecting the worker and the surrounding environment, and in no danger of damaging the water channel system.

In addition, the water treatment agent 5 produced by the present invention is the massive water treatment agent of the water-soluble amorphous and has the cracks formed at the depth between 1.0 mm and 1.5 mm from the upper and lower surfaces. Therefore, when putting in the water within the water channel system, the water treatment agent 5 does not disappear for a certain amount of time, about three to four months without dissolving a short period of time, and can keep the medicinal effect.

More specifically, on the assumption that the surface of the water treatment agent is a flat surface when the present water treatment agent is put in the water within the water channel system, the contact area with the water is small, and the period after dissolving before disappearing is elongated, however, the amount of elution of the component into the water is small. Therefore, a sufficient medicinal effect cannot be obtained. Further, on the contrary, in a case where the deep cracks are formed on the surface of the water treatment agent, the contact area with the water is increased, and the amount of elution of the component into the water is therefore increased, however, the period after dissolving before disappearing becomes extremely short. More specifically, a service life of the water treatment agent becomes short. Further, in some cases, the water treatment agent may be dissolved into pieces.

Therefore, the water treatment agent 5 produced by the present invention has the cracks formed at the depth between 1.0 mm and 1.5 mm from the upper and lower surfaces, and the contact area with the water is accordingly greater than the structure in which the surface is the flat surface. As a result, the amount of elution of the component into the water is increased, and it is possible to elongate the period after dissolving before disappearing in comparison with the case where the deep cracks are formed.

1. A method of producing a water treatment agent which can inhibit and remove a silica scale, the method comprising the following steps a to g:
a. continuously cooling a metal mold with a flowing water by arranging the metal mold in the flowing water except an upper portion of the metal mold;
b. using silicone oxide (SiO2), and sodium oxide (Na2O) as a main component, mixing one kind or plural kinds of aluminum oxide (Al2O3), magnesium oxide (MgO) or boron oxide (B2O3) as occasion demands, heating and melting them to a temperature between 1200° C. and 1300° C., and storing them within the metal mold, and when injecting the materials, the materials are injected to a position which is a little below an upper edge of a cavity in the metal mold;
c. next, pouring the cooling water like a shower from the above of the stored material in such a manner as to be uniform after 10 second to 20 second has passes after storing in the metal mold, cooling a temperature of the material up to around 800° C., and solidifying the material;
d. next, reversing the metal mold and dropping the solidified material onto a net;
e. thereafter, pouring the cooling water again thereto for 30 seconds to 40 seconds from the above and the below and cooling the material up to around 500° C.;
f. next, moving it onto the other net, pouring the cooling water again for 30 seconds to 40 seconds from the above and the below, and cooling the material up to around 100° C.;
g. thereafter, naturally drying and naturally cooling, so that the massive water treatment agent of the water-soluble amorphous is completed, and the water treatment agent can inhibit and remove the silica scale, and cracks each having a depth between 1.0 mm and 1.5 mm are formed in the water treatment agent from upper and lower surfaces.
